(19) United States
(12) Patent Application Publication
(10) Pub. No.: US 2019/0187532 A1
(43) Pub. Date: Jun. 20, 2019

(54) ELECTROCHROMIC DEVICES AND METHODS OF MAKING AND USE THEREOF

(71) Applicant: BOARD OF REGENTS, THE UNIVERSITY OF TEXAS SYSTEM, Austin, TX (US)

(72) Inventors: Delia Milliron, Austin, TX (US); Yang Wang, Newark, DE (US)

(21) Appl. No.: 16/328,399

(22) PCT Filed: Aug. 24, 2017
(86) PCT No.: PCT/US2017/048365

§ 371 Date: Feb. 26, 2019

Related U.S. Application Data
(60) Provisional application No. 62/379,862, filed on Aug. 26, 2016.

(51) Int. Cl. G02F 1/1523; G02F 1/155; G02F 1/163; G02F 1/153

(52) U.S. Cl. CPC G02F 1/1525; G02F 1/155; G02F 2001/1555; G02F 1/1533; G02F 1/163

(57) ABSTRACT

Disclosed herein are electrochromic devices. The electrochromic devices can comprise: an electrochromic electrode comprising an electrochromic layer and a first conducting layer; an electrolyte comprising an ion source; and a counter electrode comprising a second conducting layer; wherein the electrochromic electrode is in electrical contact with the counter electrode; and wherein the electrochromic electrode and the counter electrode are in electrochemical contact with the electrolyte. In some examples, the electrochromic devices can have s charge capacity of 10 mC/cm² or more after being photocharged for 20 minutes or less at an applied electrical bias of 2 V or less.

### CROSS-REFERENCE TO RELATED APPLICATIONS

This application claims the benefit of priority to U.S. Provisional Application No. 62/379,862, filed Aug. 26, 2016, which is hereby incorporated herein by reference in its entirety.

### STATEMENT OF GOVERNMENT SUPPORT

This invention was made with government support under Grant No. DE-AR0000489 awarded by Department of Energy. The government has certain rights in this invention.

### BACKGROUND

Electrochromic films undergo changes to their optical properties under electrochemical bias providing optical contrast on demand The applied electrochemical bias causes electrochemical redox reactions in electrochromic materials, resulting in the change in optical properties. The switching between different optical states upon the application of an electrochemical bias should be fast and reversible for at least thousands of cycles. Transition metal oxides are a large family of materials possessing various interesting properties in the field of electrochromism.

A large portion of the world's energy expenditure is devoted to the heating, cooling, and lighting of buildings. As the color change is persistent and energy need only be applied to effect a change, electrochromic materials can be used to control the amount of light and heat allowed to pass through windows (e.g., “smart windows”), though other industrial applications for electrochromic materials include optical filters and displays.

Electrochromic windows are emerging as a promising technology to reduce heating, cooling, and lighting energy consumption in buildings and vehicles. As many electrochromic devices operate like a lithium ion battery, they need to be charged with electrons and lithium ions before operations.

Conventional charging methods for electrochromic devices can be categorized into two different types. One is pre-charging, such as H₂ gas reduction and electrochemical reduction with Li metal, which is normally conducted before device assembly. However, these methods normally require inert or well-controlled atmosphere, and thus they are difficult to scale up. The other type of charging is in-device charging, which is performed after device assembly and can be easily scaled-up. A common in-device charging method is to electrochemically oxidize a sacrificial electron donor to generate electrons for charging. However, this oxidation reaction often requires a high electrochemical bias (e.g., >2.5 V) that can lead to decomposition of electrodes and/or electrolyte components, thus affecting the device durability. Thus, there is a need for durable devices that can be charged efficiently and for efficient and scalable charging methods. The devices and methods discussed herein address these and other needs.

### SUMMARY

In accordance with the purposes of the disclosed devices and methods, as embodied and broadly described herein, the disclosed subject matter relates to electrochromic devices and methods of making and using the devices.

Additional advantages of the disclosed devices and methods will be set forth in part in the description which follows, and in part will be obvious from the description. The advantages of the disclosed devices will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a schematic diagram of an electrochromic device.

FIG. 2 is a schematic diagram of an electrochromic device.

FIG. 3 is a schematic diagram of an electrochromic device.

FIG. 4 is a schematic diagram of an electrochromic device with in-device charging method by electrochemically oxidizing a sacrificial electron donor to generate electrons for charging.

FIG. 5 is a schematic diagram of an electrochromic device exemplifying System 1.

FIG. 6 is a photograph of an electrochromic device exemplifying System 1.

FIG. 7 shows the solvent and various organic hole scavengers investigated in the electrolyte of System 1.

FIG. 8 shows the photocurrent of the device of System 1 at different voltages with the lights on and off with various hole scavengers.

FIG. 9 is a schematic diagram of an electrochromic device exemplifying System 1.

FIG. 10 shows the charge capacity of System 1 with various organic hole scavengers over time.

FIG. 11 shows the electrochromic switching for a photocharged WO₃ film. The left panel shows a graph of current (black trace, left axis) and charge density (red, right axis) for 5 full charge and discharge cycles. The two photographs on the right panel show the electrochromic switching of the photocharged WO₃ film.

FIG. 12 is a schematic diagram of an electrochromic device exemplifying System 2.

FIG. 13 shows the current (blue trace, left axis) and charge (red trace, right axis) during photocharging for the electrochromic device of FIG. 12.

FIG. 14 shows the transmittance spectra in the clear and dark state for WO₃ (blue) and NiO (orange) before (thin lines) and after (thick lines) photocharging of the device in FIG. 12.

FIG. 15 shows the transmittance spectra in the clear and dark state when the WO₃ and NiO are stacked together. The clear and dark state can be reached by applying 2 V and −2 V.

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

Electrochromic Devices

Disclosed herein are electrochromic devices. The electrochromic devices can comprise an electrochromic electrode comprising an electrochromic layer and a first conducting layer; an electrolyte comprising an ion source; and a counter electrode comprising a second conducting layer; wherein the electrochromic electrode is in electrical contact with the counter electrode; and wherein the electrochromic electrode and the counter electrode are in electrochemical contact with the electrolyte. In response to electrical stimulus, electronic charge can move in or out of the electrochromic layer and ionic charge from the electrolyte can migrate towards or away from the electrochromic layer, thus affecting the optical properties of the electrochromic layer. The electrochromic device can comprise, for example, a touch panel, an electronic display, a transistor, a smart window, or a combination thereof.

Electrochromic layers can control optical properties such as optical transmission, absorption, reflectance, and/or emittance in a continual but reversible manner on application of a voltage. Electrochromic layers can also be used to reduce near infrared transmission. The electrochromic layers can comprise electrochromic materials. Some electrochromic materials can be colored by reduction, such as WO₃, MoO₃, V₂O₅, Nb₂O₅ or TiO₂, and other electrochromic materials can be colored by oxidation, such as Cr₂O₃, MnO₂, CoO or NiO.

In some examples, the electrochromic layer can transition from different optical states. These different states can be referred to herein as a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more (e.g., 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more) at one or more wavelengths from 400 nm to 2200 nm. For example, the first optical state can be substantially transparent at one or more wavelengths from 400 nm to 2200 nm and the second optical state can be substantially opaque at one or more wavelengths from 400 nm to 2200 nm. The use of the terms first and second here is not intended to imply that there are only two distinct optical states, but rather that the electrochromic layer can change between different optical states.

In some examples, the electrochromic layer can be switched from the first optical state to the second optical state and/or from the second optical state to the first optical state upon application of a potential to the electrochromic electrode. In some examples, the potential applied to the electrochromic electrode can be −2 volts (V) or more (e.g., −1.75 V or more, −1.5 V or more, −1.25 V or more, −1 V or more, −0.75 V or more, −0.5 V or more, −0.25 V or more, 0 V or more, 0.25 V or more, 0.5 V or more, 0.75 V or more, 1 V or more, 1.25 V or more, 1.5 V or more, or 1.75 V or more). In some examples, the potential applied to the electrochromic electrode can be 2 V or less (e.g., 1.75 V or less, 1.5 V or less, 1.25 V or less, 1 V or less, 0.75 V or less, 0.5 V or less, 0.25 V or less, 0 V or less, −0.25 V or less, −0.5 V or less, −0.75 V or less, −1 V or less, −1.25 V or less, −1.5 V or less, or −1.75 V or less). The potential applied to the electrochromic electrode can range from any of the minimum values described above to any of the maximum values described above. For example, the potential applied to the electrochromic electrode can be from −2 V to 2 V (e.g., from −2 V to 0 V, from 0 V to 2 V, from −2 V to −1 V, from −1 V to 0 V, from 0 V to 1 V, from 1 V to 2 V, or from −1.75 V to 1.75 V).

In some examples, the potential can be applied to the electrochromic electrode for 30 seconds (s) or more (e.g., 35 s or more, 40 s or more, 45 s or more, 50 s or more, 55 s or more, 1 minute (min) or more, 1.25 min or more, 1.5 min or more, 1.75 min or more, 2 min or more, 2.25 min or more, 2.5 min or more, 2.75 min or more, 3 min or more, 3.25 min or more, 3.5 min or more, 3.75 min or more, 4 min or more, 4.25 min or more, 4.5 min or more, or 4.75 min or more). In some examples, the potential can be applied to the electrochromic electrode for 5 minutes (min) or less (e.g., 4.75 min or less, 4.5 min or less, 4.25 min or less, 4 min or less, 3.75 min or less, 3.5 min or less, 3.25 min or less, 3 min or less, 2.75 min or less, 2.5 min or less, 2.25 min or less, 2 min or less, 1.75 min or less, 1.5 min or less, 1.25 min or less, 1 min or less, 55 s or less, 50 s or less, 45 s or less, 40 s or less, or 35 s or less). The time the potential is applied to the electrochromic electrode can range from any of the minimum values described above to any of the maximum values described above. For example, the potential can be applied to the electrochromic electrode for from 30 s to 5 minutes (e.g., from 30 s to 2.75 min, from 2.75 min to 5 min, from 30 s to 1 min, from 1 min to 1.5 min, from 1.5 min to 2 min, from 2 min to 2.5 min, from 2.5 min to 3 min, from 3 min to 3.5 min, from 3.5 min to 4 min, from 4 min to 4.5 min, from 4.5 min to 5 min, or from 45 sec to 4.75 min). In some examples, the time the potential is applied to the electrochromic electrode to switch the electrochromic electrode from the first optical state to the second optical state can be referred to as the switching speed.

In some examples, the electrochromic electrode can be durable. As used herein, durability of the electrochromic electrode means that one or more properties (e.g., charge capacity, transmittance of the first optical state, transmittance of the second optical state) decreases by 5% or less (e.g., 4.75% or less, 4.5% or less, 4.25% or less, 4% or less, 3.75% or less, 3.5% or less, 3.25% or less, 3% or less, 2.75% or less, 2.5% or less, 2.25% or less, 2% or less, 1.75% or less, 1.5% or less, 1.25% or less, 1% or less, 0.75% or less, 0.5% or less, or 0.25% or less) over 10 cycles or more (e.g., 50 cycles or more, 100 cycles or more, 200 cycles or more, 300 cycles or more, 400 cycles or more, 500 cycles or more, 600 cycles or more, 700 cycles or more, 800 cycles or more, 900 cycles or more, or 1000 cycles or more). As used herein, a cycle refers to the electrochromic layer switching from the first optical state to the second optical state, and then back from the second optical state to the first optical state.

The electrochromic layer can, for example, have a thickness of 200 nanometers (nm) or more (e.g., 250 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the electrochromic layer can have a thickness of 1000 nm or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, or 250 nm or less). The thickness of the electrochromic layer can range from any of the minimum values described above to any of the maximum values described above. For example, the electrochromic layer can have a thickness of from 200 nm to 1000 nm (e.g., from 200 nm to 600 nm, from 600 nm to 1000 nm, from 200 nm to 400 nm, from 400 nm to 600 nm, from 600 nm to 800 nm, from 800 nm to 1000 nm, or from 250 nm to 950 nm).

In some examples, the electrochromic layer can comprise a metal oxide. Examples of metal oxides include simple metal oxides (e.g., with a single metal element) and mixed metal oxides (e.g., with different metal elements). In some examples, the electrochromic layer can comprise a metal oxide where the metal is selected from the group consisting of Mo, Nb, Ti, V, W, Ta, and combinations thereof. In some examples, the electrochromic layer can comprise a metal oxide where the metal is selected from the group consisting of Mo, Nb, Ti, V, W, Ta, and combinations thereof, and wherein the oxygen is present in the metal oxide in a non-stoichiometric amount. In some examples, the electrochromic layer can comprise WO₃, MoO₃, V₂O₅, Nb₂O₅, TiO₂, Ta₂O₅, or combinations thereof.

In some examples, the electrochromic layer can comprise a plurality of nanocrystals, a plurality of nanoparticles, or a combination thereof. The plurality of nanocrystals, plurality of nanoparticles, or a combination thereof can have an average particle size. “Average particle size” and “mean particle size” are used interchangeably herein, and generally refer to the statistical mean particle size of the nanocrystals and/or nanoparticles in a population of nanocrystals and/or nanoparticles. For example, the average particle size for a plurality of nanocrystals and/or nanoparticles with a substantially spherical shape can comprise the average diameter of the plurality of nanocrystals and/or nanoparticles. For a nanocrystal and/or nanoparticle with a substantially spherical shape, the diameter of a nanocrystal and/or nanoparticle can refer, for example, to the hydrodynamic diameter. As used herein, the hydrodynamic diameter of a nanocrystal and/or nanoparticle can refer to the largest linear distance between two points on the surface of the nanocrystal and/or nanoparticle. For an anisotropic nanocrystal and/or nanoparticle, the average particle size can refer to, for example, the average maximum dimension of the nanocrystal and/or nanoparticle (e.g., the length of a rod shaped particle, the diagonal of a cube shape particle, the bisector of a triangular shaped particle, etc.) For an anisotropic nanocrystal and/or nanoparticle, the average particle size can refer to, for example, the hydrodynamic size of the nanocrystal and/or nanoparticle. Mean particle size can be measured using methods known in the art, such as evaluation by scanning electron microscopy, transmission electron microscopy, and/or dynamic light scattering.

The plurality of nanocrystals, the plurality of nanoparticles, or a combination thereof can, for example, have an average particle size of 3 nm or more (e.g., 4 nm or more, 5 nm or more, 6 nm or more, 7 nm or more, 8 nm or more, 9 nm or more, 10 nm or more, 11 nm or more, 12 nm or more, 13 nm or more, 14 nm or more, 15 nm or more, 16 nm or more, 17 nm or more, 18 nm or more, 19 nm or more, 20 nm or more, 21 nm or more, 22 nm or more, 23 nm or more, 24 nm or more, 25 nm or more, 26 nm or more, 27 nm or more, 28 nm or more, or 29 nm or more). In some examples, the plurality of nanocrystals, the plurality of nanoparticles, or a combination thereof can have an average particle size of 30 nm or less (e.g., 29 nm or less, 28 nm or less, 27 nm or less, 26 nm or less, 25 nm or less, 24 nm or less, 23 nm or less, 22 nm or less, 21 nm or less, 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, 5 nm or less, or 4 nm or less). The average particle size of the plurality of nanocrystals, the plurality of nanoparticles, or a combination thereof can range from any of the minimum values described above to any of the maximum values described above. For example, the plurality of nanocrystals, the plurality of nanoparticles, or a combination thereof can have an average particle size of from 3 nm to 30 nm (e.g., from 3 nm to 15 nm, from 15 nm to 30 nm, from 3 nm to 10 nm, from 10 nm to 20 nm, from 20 nm to 30 nm, or from 5 nm to 25 nm).

In some examples, the plurality of nanocrystals, the plurality of nanoparticles, or a combination thereof can be substantially monodisperse. “Monodisperse” and “homogeneous size distribution,” as used herein, and generally describe a population of nanocrystals and/or nanoparticles where all of the nanocrystals and/or nanoparticles are the same or nearly the same size. As used herein, a monodisperse distribution refers to nanocrystal and/or nanoparticle size distributions in which 70% of the distribution (e.g., 75% of the distribution, 80% of the distribution, 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of nanocrystals, the plurality of nanoparticles, or a combination thereof can comprise nanocrystals and/or nanoparticles of any shape (e.g., sphere, rod, cube, rectangle, octahedron, truncated octahedron, plate, cone, prism, ellipse, triangle, etc.). In some examples, the plurality of nanocrystals, the plurality of nanoparticles, or a combination thereof can have an isotropic shape. In some examples, the plurality of nanocrystals, the plurality of nanoparticles, or a combination thereof can have an anisotropic shape.

In some examples, the first conducting layer and/or the second conducting layer can comprise a transparent conducting oxide, a carbon material, a nanostructured metal, or a combination thereof. As used herein, “nanostructured” means any structure with one or more nanosized features. A nanosized feature can be any feature with at least one dimension less than 1 micrometer (μm) in size. For example, a nanosized feature can comprise a nanowire, nanotube, nanoparticle, nanopore, and the like, or combinations thereof. As such, the nanostructured metal can comprise, for example, a nanowire, nanotube, nanoparticle, nanopore, or a combination thereof. In some examples, the nanostructured metal can comprise a metal that is not nanosized but has been modified with a nanowire, nanotube, nanoparticle, nanopore, or a combination thereof. The nanostructured metal can comprise, for example, a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

Examples of carbon materials include, but are not limited to, graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art.

In some examples, the first conducting layer and/or the second conducting layer can comprise a transparent conducting oxide. In some examples, the first conducting layer and/or the second conducting layer can comprise a metal oxide. Examples of metal oxides include simple metal oxides (e.g., with a single metal element) and mixed metal oxides (e.g., with different metal elements). The metal oxide can, for example, comprise a metal selected from the group consisting of Cd, Cr, Cu, Ga, In, Ni, Sn, Ti, W, Zn, and combinations thereof. In some examples, the conducting layer can comprise CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, or combinations thereof.

In some examples, the first conducting layer and/or the second conducting layer can further comprise a dopant. The dopant can comprise any suitable dopant for the first conducting layer and/or the second conducting layer can. The dopant can, for example, be selected to tune the optical and/or electronic properties of the nanostructured conducting film.

In some examples, the first conducting layer and/or the second conducting layer can comprise a transparent conducting oxide selected from indium doped tin oxide, tin doped indium oxide, fluorine doped tin oxide, and combinations thereof.

The ion source can comprise H⁺ ions, Li⁺ ions, Na⁺ ions, K⁺ ions, Mg²⁺ ions, Ca²⁺ ions, Al³⁺ ions, or combinations thereof. For example, the ion source can comprise a lithium ion salt selected from the group consisting of bis(trifluoromethane)sulfonamide lithium salt (LiTFSI), LiI, LiPH₆, LiBF₄, LiClO₄, and combinations thereof.

The concentration of the ion source in the electrolyte can be, for example, 0.001 molar (M; mol/L) or more (e.g., 0.0025 M or more, 0.005 M or more, 0.0075 M or more, 0.01 M or more, 0.025 M or more, 0.05 M or more, 0.075 M or more, 0.1 M or more, 0.25 M or more, 0.5 M or more, 0.75 M or more, 1 M or more, 1.25 M or more, 1.5 M or more, 1.75 M or more, 2 M or more, 2.25 M or more, 2.5 M or more, or 2.75 M or more). In some examples, the concentration of the ion source in the electrolyte can be 3 M or less (e.g., 2.75 M or more, 2.5 M or more, 2.25 M or more, 2 M or more, 1.75 M or more, 1.5 M or more, 1.25 M or more, 1 M or more, 0.75 M or more, 0.5 M or more, 0.25 M or more, 0.1 M or more, 0.075 M or more, 0.05 M or more, 0.025 M or more, 0.001 M or more, 0.0075 M or more, 0.005 M or more, or 0.0025 M or more). The concentration of the ion source in the electrolyte can range from any of the minimum values described above to any of the maximum values described above. For example, the ion source can have a concentration in the electrolyte of from 0.001 M to 3 M (e.g., from 0.001 M to 1.5 M, from 1.5 M to 3 M, from 0.001 M to 0.01 M, from 0.01 M to 0.1 M, from 0.1 M to 1 M, from 0.001 M to 1 M, from 0.025 M to 0.4 M, from 0.05 M to 0.3 M, or from 0.075 to 0.2 M). In some examples, the concentration of the ion source in the electrolyte is 0.1 M.

The electrolyte can, in some example, further comprise a solvent selected from the group consisting of tetraglyme, propylene carbonate, diglyme, dimethyl sulfoxide (DMSO), dimethyl formamide (DMF), dimethoxyethane, and combinations thereof.

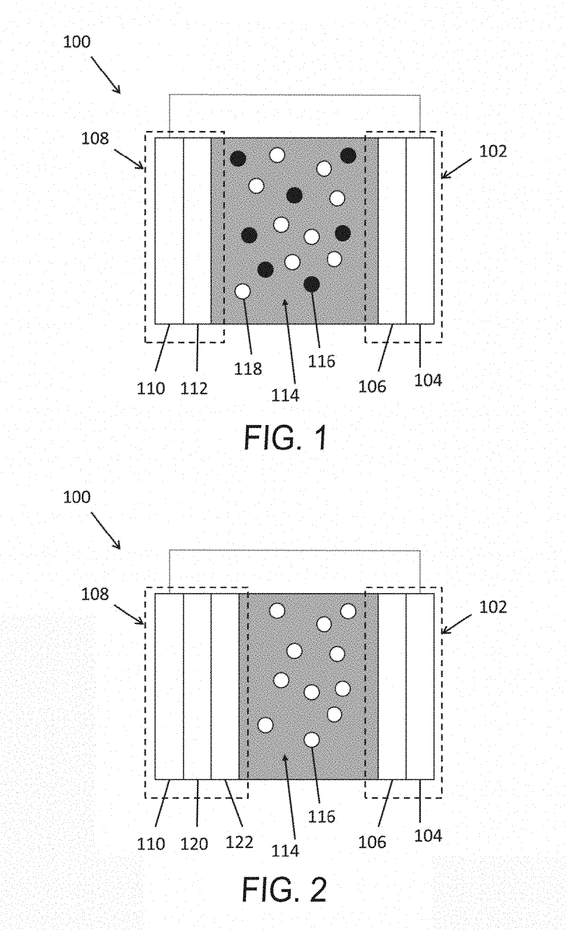

Referring now to FIG. 1, in some examples, the electrochromic devices 100 can comprise an electrochromic electrode 102 comprising a first conducting layer 104 and an electrochromic layer 106, wherein the first conducting layer 104 is in electrical contact with the electrochromic layer 106; a counter electrode 108 comprising a second conducting layer 110 and a counter layer 112, wherein the second conducting layer 110 is in electrical contact with the counter layer 112; and an electrolyte 114 comprising a hole scavenger 116 and an ion source 118; wherein the first conducting layer 104 is in electrical contact with the second conducing layer 110; and wherein the electrochromic layer 106 and the counter layer 112 are in electrochemical contact with the electrolyte 114. In response to electrical stimulus, electronic charge can move out of the electrochromic layer and ionic charge from the electrolyte can migrate towards the counter layer, thus affecting the optical properties of the electrochromic layer. The electrochromic device can comprise, for example, a touch panel, an electronic display, a transistor, a smart window, or a combination thereof.

The counter layer can, for example, comprise CeO₂, IrO₂, NiO, Prussian blue, an electrochromic polymer, or combination thereof. In some examples, the counter layer comprises CeO₂. Electrochromic polymers include, but are not limited to, polythiophenes, polypyrroles, polyanilines, polyfurans, polycarbazoles, or other electrochromic polymers known in the art (Wang Y et al. Annual Review of Chemical and Biomolecular Engineering, 2016, 7(1), 283-304; Mortimer R J. Annual Review of Materials Research, 2011, 41(1), 241-268; Beaujuge P M et al. Nature Materials, 2008, 7(10), 795-799).

The counter layer can have a thickness of 500 nm or more (e.g., 550 nm or more, 600 nm or more, 650 nm or more, 700 nm or more, 750 nm or more, 800 nm or more, 850 nm or more, 900 nm or more, 950 nm or more, 1000 nm or more, 1100 nm or more, 1200 nm or more, 1300 nm or more, 1400 nm or more, 1500 nm or more, 1600 nm or more, 1700 nm or more, 1800 nm or more, or 1900 nm or more). In some examples, the counter layer can have a thickness of 2000 nm or less (e.g., 1900 nm or less, 1800 nm or less, 1700 nm or less, 1600 nm or less, 1500 nm or less, 1400 nm or less, 1300 nm or less, 1200 nm or less, 1100 nm or less, 1000 nm or less, 950 nm or less, 900 nm or less, 850 nm or less, 800 nm or less, 750 nm or less, 700 nm or less, 650 nm or less, 600 nm or less, or 550 nm or less). The thickness of the counter layer can range from any of the minimum values described above to any of the maximum values described above. For example, the counter layer can have a thickness of from 500 nm to 2000 nm (e.g., from 500 nm to 1200 nm, form 1200 nm to 2000 nm, from 500 nm to 1000 nm, from 1000 nm to 1500 nm, from 1500 nm to 2000 nm, or from 500 nm to 1500 nm).

The hole scavenger can comprise a sacrificial compound that can be irreversibly oxidized by photochemical or electrochemical means to provide electrons for charging the electrochromic device. The hole scavenger can, for example, comprise a compound with a an oxidation potential of 1.4 volts (V) or less (e.g., 1.2 V or less, 1 V or less, 0.8 V or less, 0.6 V or less, 0.4 V or less, or 0.2 V or less). Examples of hole scavengers include, but are not limited to, methoxybenzyl alcohol, phenol, methoxy-benzyl thiol, mercaptopropionic acid, 6-mercaptohexanoic acid, 11-mercaptoundecanoic acid, benzyl alcohol, 4-nitrobenzyl alcohol, 4-chlorobenzyl alcohol, 4-methylbenzyl alcohol, 3-methoxybenzyl alcohol, 2-methoxybenzyl alcohol, and combinations thereof. In some examples, the hole scavenger comprises mercaptopropionic acid.

The hole scavenger can have a concentration in the electrolyte of 0.001 M or more (e.g., 0.0025 M or more, 0.005 M or more, 0.0075 M or more, 0.01 M or more, 0.025 M or more, 0.05 M or more, 0.075 M or more, 0.1 M or more, 0.25 M or more, 0.5 M or more, or 0.75 M or more). In some examples, the hole scavenger can have a concentration in the electrolyte of 1 M or less (e.g., 0.75 M or less, 0.5 M or less, 0.25 M or less, 0.1 M or less, 0.075 M or less, 0.05 M or less, 0.025 M or less, 0.01 M or less, 0.0075 M or less, 0.005 M or less, or 0.0025 M or less). The concentration of the hole scavenger in the electrolyte can range from any of the minimum values described above to any of the maximum values described above. For example, the hole scavenger can have a concentration in the electrolyte of from 0.001 M to 1 M (e.g., from 0.001 to 0.5 M, from 0.5 M to 1 M, from 0.001 M to 0.01 M, from 0.01 M to 0.1 M, from 0.1 M to 1 M, from 0.025 M to 0.4 M, from 0.05 M to 0.3 M, or from 0.075 to 0.2 M). In some examples, the hole scavenger has a concentration in the electrolyte of 0.1 M.

Referring now to FIG. 2, in some examples, the electrochromic devices 100 can comprise an electrochromic electrode 102 comprising a first conducting layer 104 and an electrochromic layer 106, wherein the first conducting layer 104 is in electrical contact with the electrochromic layer 106; a counter electrode 108 comprising a second conducting layer 110, a photosensitive layer 120, and a hole scavenger layer 122, wherein the photosensitive layer 120 is disposed between the second conducting layer 110 and the hole scavenger layer 122 such that the photosensitive layer 120 is in electrical contact with the second conducting layer 110 and the hole scavenger layer 122; and an electrolyte 114 comprising an ion source 116; wherein the first conducting layer 104 is in electrical contact with the second conducting layer 110; and wherein the electrochromic layer 106 is in electrochemical contact with the electrolyte 114. In response to electrical stimulus, electronic charge can move out of the photosensitive layer and ionic charge from the electrolyte can migrate towards the electrochromic layer, thus affecting the optical properties of the electrochromic layer. The electrochromic device can comprise, for example, a touch panel, an electronic display, a transistor, a smart window, or a combination thereof.

The hole scavenger layer can comprise a material that can act as a reversible hole acceptor. For example, the hole scavenger layer can comprise NiO, IrO₂, Prussian blue, an electrochromic polymer, or combinations thereof.

In some examples, the hole scavenger layer can comprise an electrochromic material, such that the hole scavenger layer comprises a second electrochromic layer that is different than the first electrochromic layer. For example, the first electrochromic layer and the second electrochromic layer can comprise electrochromic materials with complementary electrochromism. For example, the first electrochromic layer can comprise an electrochromic material that can be colored by reduction, while the second electrochromic layer can comprise an electrochromic material can be colored by oxidation, or vice versa.

In some examples, the second electrochromic layer can have a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more (e.g., 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more) at one or more wavelengths from 400 nm to 2200 nm. For example, the first optical state can be substantially transparent at one or more wavelengths from 400 nm to 2200 nm and the second optical state can be substantially opaque at one or more wavelengths from 400 nm to 2200 nm.

In some examples, the second electrochromic layer can be switched from the first optical state to the second optical state and/or from the second optical state to the first optical state upon application of a potential to the counter electrode.

In some examples, the potential applied to the counter electrode can be −2 volts (V) or more (e.g., −1.75 V or more, −1.5 V or more, −1.25 V or more, −1 V or more, −0.75 V or more, −0.5 V or more, −0.25 V or more, 0 V or more, 0.25 V or more, 0.5 V or more, 0.75 V or more, 1 V or more, 1.25 V or more, 1.5 V or more, or 1.75 V or more). In some examples, the potential applied to the counter electrode can be 2 V or less (e.g., 1.75 V or less, 1.5 V or less, 1.25 V or less, 1 V or less, 0.75 V or less, 0.5 V or less, 0.25 V or less, 0 V or less, −0.25 V or less, −0.5 V or less, −0.75 V or less, −1 V or less, −1.25 V or less, −1.5 V or less, or −1.75 V or less). The potential applied to the counter electrode can range from any of the minimum values described above to any of the maximum values described above. For example, the potential applied to the counter electrode can be from −2 V to 2 V (e.g., from −2 V to 0 V, from 0 V to 2 V, from −2 V to −1 V, from −1 V to 0 V, from 0 V to 1 V, from 1 V to 2 V, or from −1.75 V to 1.75 V).

In some examples, the potential can be applied to the counter electrode for 30 seconds (s) or more (e.g., 35 s or more, 40 s or more, 45 s or more, 50 s or more, 55 s or more, 1 minute (min) or more, 1.25 min or more, 1.5 min or more, 1.75 min or more, 2 min or more, 2.25 min or more, 2.5 min or more, 2.75 min or more, 3 min or more, 3.25 min or more, 3.5 min or more, 3.75 min or more, 4 min or more, 4.25 min or more, 4.5 min or more, or 4.75 min or more). In some examples, the potential can be applied to the counter electrode for 5 minutes (min) or less (e.g., 4.75 min or less, 4.5 min or less, 4.25 min or less, 4 min or less, 3.75 min or less, 3.5 min or less, 3.25 min or less, 3 min or less, 2.75 min or less, 2.5 min or less, 2.25 min or less, 2 min or less, 1.75 min or less, 1.5 min or less, 1.25 min or less, 1 min or less, 55 s or less, 50 s or less, 45 s or less, 40 s or less, or 35 s or less). The time the potential is applied to the counter electrode can range from any of the minimum values described above to any of the maximum values described above. For example, the potential can be applied to the counter electrode for from 30 s to 5 minutes (e.g., from 30 s to 2.75 min, from 2.75 min to 5 min, from 30 s to 1 min, from 1 min to 1.5 min, from 1.5 min to 2 min, from 2 min to 2.5 min, from 2.5 min to 3 min, from 3 min to 3.5 min, from 3.5 min to 4 min, from 4 min to 4.5 min, from 4.5 min to 5 min, or from 45 sec to 4.75 min). In some examples, the time the potential is applied to the counter electrode to switch the electrochromic electrode from the first optical state to the second optical state can be referred to as the switching speed.

In some examples, the counter electrode can be durable. As used herein, durability of the counter electrode means that one or more properties (e.g., charge capacity, transmittance of the first optical state, transmittance of the second optical state) decreases by 5% or less (e.g., 4.75% or less, 4.5% or less, 4.25% or less, 4% or less, 3.75% or less, 3.5% or less, 3.25% or less, 3% or less, 2.75% or less, 2.5% or less, 2.25% or less, 2% or less, 1.75% or less, 1.5% or less, 1.25% or less, 1% or less, 0.75% or less, 0.5% or less, or 0.25% or less) over 10 cycles or more (e.g., 50 cycles or more, 100 cycles or more, 200 cycles or more, 300 cycles or more, 400 cycles or more, 500 cycles or more, 600 cycles or more, 700 cycles or more, 800 cycles or more, 900 cycles or more, or 1000 cycles or more).

The second electrochromic layer can, for example, have a thickness of 200 nm or more (e.g., 225 nm or more, 250 nm or more, 275 nm or more, 300 nm or more, 325 nm or more, 350 nm or more, 375 nm or more, 400 nm or more, 425 nm or more, 450 nm or more, or 475 nm or more). In some examples, the second electrochromic layer can have a thickness of 500 nm or less (e.g., 475 nm or less, 450 nm or less, 425 nm or less, 400 nm or less, 375 nm or less, 350 nm or less, 325 nm or less, 300 nm or less, 275 nm or less, 250 nm or less, or 225 nm or less). The thickness of the second electrochromic layer can range from any of the minimum values described above to any of the maximum values described above. For example, the second electrochromic layer can have a thickness of from 200 nm to 500 nm (e.g., from 200 nm to 350 nm, from 350 nm to 500 nm, from 200 nm to 300 nm, from 300 nm to 400 nm, from 400 nm to 500 nm, or from 225 nm to 475 nm).

In some examples, the second electrochromic layer can comprise a metal oxide. Examples of metal oxides include simple metal oxides (e.g., with a single metal element) and mixed metal oxides (e.g., with different metal elements). In some examples, the second electrochromic layer can comprise a metal oxide where the metal is selected from the group consisting of Ni, Ir, and combinations thereof. In some examples, the second electrochromic layer can comprise a metal oxide where the metal is selected from the group consisting of Ni, Ir, and combinations thereof, and wherein the oxygen is present in the metal oxide in a non-stoichiometric amount. In some examples, the second electrochromic layer can comprise NiO, IrO₂, or combinations thereof.

In some examples, the second electrochromic layer can comprise a plurality of nanocrystals, a plurality of nanoparticles, or a combination thereof. The plurality of nanocrystals, plurality of nanoparticles, or a combination thereof can have an average particle size. “Average particle size” and “mean particle size” are used interchangeably herein, and generally refer to the statistical mean particle size of the nanocrystals and/or nanoparticles in a population of nanocrystals and/or nanoparticles. For example, the average particle size for a plurality of nanocrystals and/or nanoparticles with a substantially spherical shape can comprise the average diameter of the plurality of nanocrystals and/or nanoparticles. For a nanocrystal and/or nanoparticle with a substantially spherical shape, the diameter of a nanocrystal and/or nanoparticle can refer, for example, to the hydrodynamic diameter. As used herein, the hydrodynamic diameter of a nanocrystal and/or nanoparticle can refer to the largest linear distance between two points on the surface of the nanocrystal and/or nanoparticle. For an anisotropic nanocrystal and/or nanoparticle, the average particle size can refer to, for example, the average maximum dimension of the nanocrystal and/or nanoparticle (e.g., the length of a rod shaped particle, the diagonal of a cube shape particle, the bisector of a triangular shaped particle, etc.) For an anisotropic nanocrystal and/or nanoparticle, the average particle size can refer to, for example, the hydrodynamic size of the nanocrystal and/or nanoparticle. Mean particle size can be measured using methods known in the art, such as evaluation by scanning electron microscopy, transmission electron microscopy, and/or dynamic light scattering. The plurality of nanocrystals, the plurality of nanoparticles, or a combination thereof can, for example, have an average particle size of 3 nm or more (e.g., 4 nm or more, 5 nm or more, 6 nm or more, 7 nm or more, 8 nm or more, 9 nm or more, 10 nm or more, 11 nm or more, 12 nm or more, 13 nm or more, 14 nm or more, 15 nm or more, 16 nm or more, 17 nm or more, 18 nm or more, 19 nm or more, 20 nm or more, 21 nm or more, 22 nm or more, 23 nm or more, 24 nm or more, 25 nm or more, 26 nm or more, 27 nm or more, 28 nm or more, or 29 nm or more). In some examples, the plurality of nanocrystals, the plurality of nanoparticles, or a combination thereof can have an average particle size of 30 nm or less (e.g., 29 nm or less, 28 nm or less, 27 nm or less, 26 nm or less, 25 nm or less, 24 nm or less, 23 nm or less, 22 nm or less, 21 nm or less, 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, 5 nm or less, or 4 nm or less). The average particle size of the plurality of nanocrystals, the plurality of nanoparticles, or a combination thereof can range from any of the minimum values described above to any of the maximum values described above. For example, the plurality of nanocrystals, the plurality of nanoparticles, or a combination thereof can have an average particle size of from 3 nm to 30 nm (e.g., from 3 nm to 15 nm, from 15 nm to 30 nm, from 3 nm to 10 nm, from 10 nm to 20 nm, from 20 nm to 30 nm, or from 5 nm to 25 nm).

In some examples, the plurality of nanocrystals, the plurality of nanoparticles, or a combination thereof can be substantially monodisperse. “Monodisperse” and “homogeneous size distribution,” as used herein, and generally describe a population of nanocrystals and/or nanoparticles where all of the nanocrystals and/or nanoparticles are the same or nearly the same size. As used herein, a monodisperse distribution refers to nanocrystal and/or nanoparticle size distributions in which 70% of the distribution (e.g., 75% of the distribution, 80% of the distribution, 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of nanocrystals, the plurality of nanoparticles, or a combination thereof can comprise nanocrystals and/or nanoparticles of any shape (e.g., sphere, rod, cube, rectangle, octahedron, truncated octahedron, plate, cone, prism, ellipse, triangle, etc.). In some examples, the plurality of nanocrystals, the plurality of nanoparticles, or a combination thereof can have an isotropic shape. In some examples, the plurality of nanocrystals, the plurality of nanoparticles, or a combination thereof can have an anisotropic shape.

The photosensitive layer can, for example, comprise a semiconductor. For example, the photosensitive layer can comprise Si, TiO₂, GaN, GaAs, CdSe, CdS, CdTe, ZnO, ZnTe, Cu₂S, SnS, InGaN, CdZnTe, Fe₂O₃, or combinations thereof. In some examples, the photosensitive layer can comprise an organic material such as those used in transparent solar cells, for example a conjugated polymer, a dye molecule, and the like.

The photosensitive layer can have a thickness of 100 nm or more (e.g., 125 nm or more, 150 nm or more, 175 nm or more, 200 nm or more, 225 nm or more, 250 nm or more, 275 nm or more, 300 nm or more, 325 nm or more, 350 nm or more, 375 nm or more, 400 nm or more, 425 nm or more, 450 nm or more, or 475 nm or more). In some examples, the photosensitive layer can have a thickness of 500 nm or less (e.g., 475 nm or less, 450 nm or less, 425 nm or less, 400 nm or less, 375 nm or less, 350 nm or less, 325 nm or less, 300 nm or less, 275 nm or less, 250 nm or less, 225 nm or less, 200 nm or less, 175 nm or less, 150 nm or less, or 125 nm or less). The thickness of the photosensitive layer can range from any of the minimum values described above to any of the maximum values described above. For example, the photosensitive layer can have a thickness of from 100 nm to 500 nm (e.g., from 100 nm to 300 nm, from 300 nm to 500 nm, from 100 nm to 200 nm, from 200 nm to 300 nm, from 300 nm to 400 nm, from 400 nm to 500 nm, or from 150 nm to 450 nm).

The electrochromic devices can, in some example, be photocharged for 20 minutes or less (e.g., 19 minutes or less, 18 minutes or less, 17 minutes or less, 16 minutes or less, 15 minutes or less, 14 minutes or less, 13 minutes or less, 12 minutes or less, 11 minutes or less, 10 minutes or less, 9 minutes or less, 8 minutes or less, 7 minutes or less, 6 minutes or less, 5 minutes or less, 4 minutes or less, 3 minutes or less, 2 minutes or less, or 1 minute or less) at an applied voltage of 2 V or less (e.g., 1.9 V or less, 1.8 V or less, 1.7 V or less, 1.6 V or less, 1.5 V or less, 1.4 V or less, 1.3 V or less, 1.2 V or less, 1.1 V or less, 1.0 V or less, 0.9 V or less, 0.8 V or less, 0.7 V or less, 0.6 V or less, 0.5 V or less, 0.4 V or less, 0.3 V or less, 0.2 V or less, or 0.1 V or less).

The electrochromic devices can, for example, have a charge capacity of 10 millicoulombs per square centimeter (mC/cm²) or more (e.g., 11 mC/cm² or more, 12 mC/cm² or more, 13 mC/cm² or more, 14 mC/cm² or more, 15 mC/cm² or more, 16 mC/cm² or more, 17 mC/cm² or more, 18 mC/cm² or more, 19 mC/cm² or more, 20 mC/cm² or more, 21 mC/cm² or more, 22 mC/cm² or more, 23 mC/cm² or more, 24 mC/cm² or more, 25 mC/cm² or more, 26 mC/cm² or more, 27 mC/cm² or more, 28 mC/cm² or more, or 29 mC/cm² or more) after 20 minutes or less of photocharging at an applied voltage of 2 V or less. In some examples, The electrochromic devices can have a charge capacity of 30 mC/cm² or less (e.g., 29 mC/cm² or less, 28 mC/cm² or less, 27 mC/cm² or less, 26 mC/cm² or less, 25 mC/cm² or less, 24 mC/cm² or less, 23 mC/cm² or less, 22 mC/cm² or less, 21 mC/cm² or less, 20 mC/cm² or less, 19 mC/cm² or less, 18 mC/cm² or less, 17 mC/cm² or less, 16 mC/cm² or less, 15 mC/cm² or less, 14 mC/cm² or less, 13 mC/cm² or less, 12 mC/cm² or less, or 11 mC/cm² or less) after 20 minutes or less of photocharging at an applied voltage of 2 V or less.

The charge capacity of the photocharged electrochromic device can range from any of the minimum values described above to any of the maximum values described above. For examples, the electrochromic devices can have a charge capacity of from 10 mC/cm² to 30 mC/cm² (e.g., from 10 mC/cm² to 20 mC/cm², from 20 mC/cm² to 30 mC/cm², from 10 mC/cm² to 15 mC/cm², from 15 mC/cm² to 20 mC/cm², from 20 mC/cm² to 25 mC/cm², from 25 mC/cm² to 30 mC/cm², or from 15 mC/cm² to 25 mC/cm²) after 20 minutes or less of photocharging at an applied voltage of 2 V or less.

In some examples, the electrochromic device can be durable. As used herein, durability of the electrochromic device means that one or more properties (e.g., charge capacity) decreases by 5% or less (e.g., 4.75% or less, 4.5% or less, 4.25% or less, 4% or less, 3.75% or less, 3.5% or less, 3.25% or less, 3% or less, 2.75% or less, 2.5% or less, 2.25% or less, 2% or less, 1.75% or less, 1.5% or less, 1.25% or less, 1% or less, 0.75% or less, 0.5% or less, or 0.25% or less) over 10 cycles or more (e.g., 50 cycles or more, 100 cycles or more, 200 cycles or more, 300 cycles or more, 400 cycles or more, 500 cycles or more, 600 cycles or more, 700 cycles or more, 800 cycles or more, 900 cycles or more, or 1000 cycles or more).

The electrochromic devices described herein can be coupled to a power supply and optionally to one or more additional suitable features including, but not limited to, a voltmeter, an ammeter, a multimeter, an ohmmeter, a signal generator, a pulse generator, an oscilloscope, a frequency counter, a potentiostat, or a capacitance meter. For example, the electrochromic device can further comprise a power supply that is in electrical contact with the electrochromic electrode and the counter electrode. In some examples, the power supply is configured to apply a potential to the electrochromic electrode, the counter electrode, or a combination thereof.

In some examples, the electrochromic devices can further comprises a light source configured to illuminate at least a portion of the electrochromic device. For example, the light source can be configured to illuminate at least a portion of the electrochromic electrode, the counter electrode, or a combination thereof. The light source can be any type of light source. In some examples, the electrochromic devices can include a single light source. In other examples, more than one light source can be included in the electrochromic devices. Examples of suitable light sources include natural light sources (e.g., sunlight) and artificial light sources (e.g., incandescent light bulbs, light emitting diodes, gas discharge lamps, arc lamps, lasers etc.). In some examples, the light source can emit electromagnetic radiation at a wavelength that overlaps with at least a portion of the bandgap of the electrochromic layer, the photosensitive layer, or a combination thereof.

Methods of Photocharging

Also described herein are methods of photocharging the electrochromic devices described herein. For example, the methods of photocharging the electrochromic devices can comprise: illuminating at least a portion of the electrochromic device with electromagnetic radiation, wherein a fist component of the electrochromic device has a band gap, and wherein a wavelength of the electromagnetic radiation overlaps with at least a portion of the band gap of the fist component of the electrochromic device, thereby generating electron-hole pairs in the first component of the electrochromic device; and applying an electrical bias to the electrochromic device to thereby separate the electron-hole pairs by driving the electrons a second component of the electrochromic device, and thereby driving ions to the second component of the electrochromic device to compensate for the electrons; thereby photocharging the electrochromic device.

In some examples, photocharging the electrochromic device can comprise: illuminating the electrochromic layer with electromagnetic radiation at a wavelength that overlaps with at least a portion of the band gap of the electrochromic layer, thereby generating electron-hole pairs in the electrochromic layer; and applying an electrical bias to the electrochromic device to thereby separate the electron-hole pairs by driving the electrons to the counter layer, thereby driving the holes to the electrolyte to react with the hole scavenger, and driving ions to the counter layer to compensate for the electrons; thereby photocharging the electrochromic device.

In some examples, photocharging the electrochromic device can comprise: illuminating the photosensitive layer with electromagnetic radiation at a wavelength that overlaps with at least a portion of the band gap of the photosensitive layer, thereby generating electron-hole pairs in the photosensitive layer; and applying an electrical bias to the electrochromic device to thereby separate the electron-hole pairs by driving the electrons to the electrochromic layer, thereby driving the holes to the hole scavenger layer, and driving ions to the electrochromic layer to compensate for the electrons; thereby photocharging the electrochromic device.

The electrical bias can, for example, comprise a voltage of 2 V or less (e.g., 1.9 V or less, 1.8 V or less, 1.7 V or less, 1.6 V or less, 1.5 V or less, 1.4 V or less, 1.3 V or less, 1.2 V or less, 1.1 V or less, 1.0 V or less, 0.9 V or less, 0.8 V or less, 0.7 V or less, 0.6 V or less, 0.5 V or less, 0.4 V or less, 0.3 V or less, 0.2 V or less, or 0.1 V or less). In some examples, the electrochromic device can be photocharged (e.g., illuminated with electromagnetic radiation and electrical bias applied) for 20 minutes or less (e.g., 19 minutes or less, 18 minutes or less, 17 minutes or less, 16 minutes or less, 15 minutes or less, 14 minutes or less, 13 minutes or less, 12 minutes or less, 11 minutes or less, 10 minutes or less, 9 minutes or less, 8 minutes or less, 7 minutes or less, 6 minutes or less, 5 minutes or less, 4 minutes or less, 3 minutes or less, 2 minutes or less, or 1 minutes or less).

The electrochromic device can have a photocurrent density of 5 microamperes per square centimeter (μA/cm²) or more during photocharging (e.g., 6 μA/cm² or more, 7 μA/cm² or more, 8 μA/cm² or more, 9 μA/cm² or more, 10 μA/cm² or more, 11 μA/cm² or more, 12 μA/cm² or more, 13 μA/cm² or more, 14 μA/cm² or more, 15 μA/cm² or more, 16 μA/cm² or more, 17 μA/cm² or more, 18 μA/cm² or more, 19 μA/cm² or more, 20 μA/cm² or more, 21 μA/cm² or more, 22 μA/cm² or more, 23 μA/cm² or more, 24 μA/cm² or more, 25 μA/cm² or more, 26 μA/cm² or more, 27 μA/cm² or more, 28 μA/cm² or more, or 29 μA/cm² or more). In some examples, the electrochromic device can have a photo current density of 30 μA/cm² or less during photocharging (e.g., 29 μA/cm² or less, 28 μA/cm² or less, 27 μA/cm² or less, 26 μA/cm² or less, 25 μA/cm² or less, 24 μA/cm² or less, 23 μA/cm² or less, 22 μA/cm² or less, 21 μA/cm² or less, 20 μA/cm² or less, 19 μA/cm² or less, 18 μA/cm² or less, 17 μA/cm² or less, 16 μA/cm² or less, 15 μA/cm² or less, 14 μA/cm² or less, 13 μA/cm² or less, 12 μA/cm² or less, 11 μA/cm² or less, 10 μA/cm² or less, 9 μA/cm² or less, 8 μA/cm² or less, 7 μA/cm² or less, or 6 μA/cm² or less). The photocurrent density of the electrochromic device during photocharging can range from any of the minimum values described above to any of the maximum values described above. For example, the electrochromic device can have a photocurrent density of from 5 μA/cm² to 30 μA/cm² during photocharging (e.g., from 5 μA/cm² to 18 μA/cm², from 18 μA/cm² to 30 μA/cm², from 5 μA/cm² to 10 μA/cm², from 10 μA/cm² to 15 μA/cm², from 15 μA/cm² to 20 μA/cm², from 20 μA/cm² to 25 μA/cm², from 25 μA/cm² to 30 μA/cm², or from 10 μA/cm² to 25 μA/cm²).

The photocharged electrochromic device can have a charge capacity of 10 mC/cm² or more (e.g., 11 mC/cm² or more, 12 mC/cm² or more, 13 mC/cm² or more, 14 mC/cm² or more, 15 mC/cm² or more, 16 mC/cm² or more, 17 mC/cm² or more, 18 mC/cm² or more, 19 mC/cm² or more, 20 mC/cm² or more, 21 mC/cm² or more, 22 mC/cm² or more, 23 mC/cm² or more, 24 mC/cm² or more, 25 mC/cm² or more, 26 mC/cm² or more, 27 mC/cm² or more, 28 mC/cm² or more, or 29 mC/cm² or more). In some examples, the photocharged electrochromic device can have a charge capacity of 30 mC/cm² or less (e.g., 29 mC/cm² or less, 28 mC/cm² or less, 27 mC/cm² or less, 26 mC/cm² or less, 25 mC/cm² or less, 24 mC/cm² or less, 23 mC/cm² or less, 22 mC/cm² or less, 21 mC/cm² or less, 20 mC/cm² or less, 19 mC/cm² or less, 18 mC/cm² or less, 17 mC/cm² or less, 16 mC/cm² or less, 15 mC/cm² or less, 14 mC/cm² or less, 13 mC/cm² or less, 12 mC/cm² or less, or 11 mC/cm² or less). The charge capacity of the photocharged electrochromic device can range from any of the minimum values described above to any of the maximum values described above. For examples, the photocharged electrochromic device can have a charge capacity of from 10 mC/cm² to 30 mC/cm² (e.g., from 10 mC/cm² to 20 mC/cm², from 20 mC/cm² to 30 mC/cm², from 10 mC/cm² to 15 mC/cm², from 15 mC/cm² to 20 mC/cm², from 20 mC/cm² to 25 mC/cm², from 25 mC/cm² to 30 mC/cm², or from 15 mC/cm² to 25 mC/cm²).

Methods of Making

Also described herein are methods of making the electrochromic devices described herein.

For example, also described herein are methods of making the electrochromic electrodes described herein. For example, also disclosed herein are methods of making the electrochromic electrodes described herein, the method comprising, for example, dispersing a plurality of nanocrystals, a plurality of nanoparticles, or a combination thereof in a solution, thereby forming a mixture; depositing the mixture on the conducting layer, thereby forming an electrochromic precursor layer on the conducting layer; and thermally annealing and/or UV curing the electrochromic precursor layer, thereby forming the electrochromic electrode. Depositing the mixture can, for example, comprise printing, lithographic deposition, spin coating, drop-casting, zone casting, dip coating, blade coating, spraying, vacuum filtration, slot die coating, curtain coating, or combinations thereof.

Thermally annealing the electrochromic precursor layer can, for example, comprise heating the electrochromic precursor layer at a temperature of 100° C. or more (e.g., 150° C. or more, 200° C. or more, 250° C. or more, 300° C. or more, 350° C. or more, 400° C. or more, 450° C. or more, 500° C. or more, 550° C. or more, 600° C. or more, 650° C. or more, 700° C. or more, 750° C. or more, 800° C. or more, 850° C. or more, 900° C. or more, or 950° C. or more). In some examples, thermally annealing the electrochromic precursor layer can comprise heating the electrochromic precursor layer at a temperature of 1000° C. or less (e.g., 950° C. or less, 900° C. or less, 850° C. or less, 800° C. or less, 750° C. or less, 700° C. or less, 650° C. or less, 600° C. or less, 550° C. or less, 500° C. or less, 450° C. or less, 400° C. or less, 350° C. or less, 300° C. or less, 250° C. or less, 200° C. or less, or 150° C. or less). The temperature at which the electrochromic precursor layer is heated to thermally anneal the electrochromic precursor layer can range from any of the minimum values described above to any of the maximum values described above. For examples, thermally annealing the electrochromic precursor layer can comprise heating the electrochromic precursor layer at a temperature of from 100° C. to 1000° C. (e.g., from 100° C. to 500° C., from 500° C. to 1000° C., from 100° C. to 250° C., from 250° C. to 400° C., from 400 ° C. to 550° C., from 550° C. to 700° C., from 700° C. to 850° C., from 850° C. to 1000° C., or from 200° C. to 900° C.).

In some examples, the electrochromic precursor layer can be thermally annealed for 1 minute or more (e.g., 5 minutes or more, 10 minutes or more, 15 minutes or more, 20 minutes or more, 25 minutes or more, 30 minutes or more, 45 minutes or more, 1 hour or more, 1.5 hours or more, 2 hours or more, 2.5 hours or more, 3 hours or more, 3.5 hours or more, 4 hours or more, 4.5 hours or more, 5 hours or more, 5.5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, or 23 hours or more). In some examples, the electrochromic precursor layer is thermally annealed for 24 hours or less (e.g., 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5.5 hours or less, 5 hours or less, 4.5 hours or less, 4 hours or less, 3.5 hours or less, 3 hours or less, 2.5 hours or less, 2 hours or less, 1.5 hours or less, 1 hour or less, 45 minutes or less, 30 minutes or less, 25 minutes or less, 20 minutes or less, 15 minutes or less, 10 minutes or less, or 5 minutes or less). The time for which the electrochromic precursor layer is thermally annealed can range from any of the minimum values described above to any of the maximum values described above. For example, the electrochromic precursor layer can be thermally annealed for from 1 minute to 24 hours (e.g., from 1 minute to 12 hours, from 12 hours to 24 hours, from 1 minute to 6 hours, from 6 hours to 12 hours, from 12 hours to 18 hours, from 18 hours to 24 hours, or from 5 minutes to 23 hours).

The electrochromic precursor layer can be thermally annealed, for example, in air, H₂, N₂, O₂, Ar, or combinations thereof.

UV curing the electrochromic precursor layer can comprise exposing the electrochromic precursor layer to UV light.

In some examples, the method can further comprise forming the plurality of nanocrystals, the plurality of nanoparticles, or a combination thereof.

Also described herein are methods of making the counter electrodes described herein. For example, the method of making the counter electrode comprising a second conducting layer and a counter layer can comprise depositing the counter layer on the second conducting layer. Depositing the counter layer can, for example, comprise atomic layer deposition, chemical vapor deposition, electron beam evaporation, thermal evaporation, sputtering deposition, pulsed laser deposition, printing, lithographic deposition, spin coating, drop-casting, zone casting, dip coating, blade coating, spraying, vacuum filtration, slot die coating, curtain coating, or combinations thereof.

Also described herein are methods of making the counter electrodes comprising a second conducting layer, a photosensitive layer, and a hole scavenger layer, wherein the photosensitive layer is disposed between the second conducting layer and the hole scavenger layer. The methods can comprise, for example, depositing the photosensitive layer on the second conducting layer and then depositing the hole scavenger layer on the photosensitive layer. Depositing the photosensitive layer on the second conducting layer and/or depositing the hole scavenger layer on the photosensitive layer can, for example, comprise atomic layer deposition, chemical vapor deposition, electron beam evaporation, thermal evaporation, sputtering deposition, pulsed laser deposition, printing, lithographic deposition, spin coating, drop-casting, zone casting, dip coating, blade coating, spraying, vacuum filtration, slot die coating, curtain coating, or combinations thereof.

In certain examples, wherein the hole scavenger layer comprises a second electrochromic layer, the methods of making the counter electrode can comprise dispersing a plurality of nanocrystals, a plurality of nanoparticles, or a combination thereof in a solution, thereby forming a second mixture; depositing the second mixture on the photosensitive layer, thereby forming a second electrochromic precursor layer on the photosensitive layer; and thermally annealing and/or UV curing the second electrochromic precursor layer, thereby forming the counter electrode. Depositing the second mixture can, for example, comprise printing, lithographic deposition, spin coating, drop-casting, zone casting, dip coating, blade coating, spraying, vacuum filtration, slot die coating, curtain coating, or combinations thereof. Thermally annealing the second electrochromic precursor layer can, for example, comprise heating the second electrochromic precursor layer at a temperature of from 100° C. to 1000° C.). In some examples, the second electrochromic precursor layer can be thermally annealed for from 1 minute to 24 hours. The second electrochromic precursor layer can be thermally annealed, for example, in air, H₂, N₂, O₂, Ar, or combinations thereof. UV curing the second electrochromic precursor layer can comprise exposing the electrochromic precursor layer to UV light. In some examples, the method can further comprise forming the plurality of nanocrystals, the plurality of nanoparticles, or a combination thereof.

Methods of Use

Also provided herein are methods of use of the electrochromic devices described herein. For example, the electrochromic devices described herein can be used in, for example, electronic displays, transistors, solar cells, and light emitting diodes (LEDs). Such devices can be fabricated by methods known in the art.

In some examples, the electrochromic devices described herein can be used in various articles of manufacture including electronic devices, energy storage devices, energy conversion devices, optical devices, optoelectronic devices, or combinations thereof. Examples of articles of manufacture (e.g., devices) using the electrochromic devices described herein can include, but are not limited to touch panels, electronic displays, transistors, smart windows, solar cells, fuel cells, photovoltaic cells, and combinations thereof. Such articles of manufacture can be fabricated by methods known in the art.

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

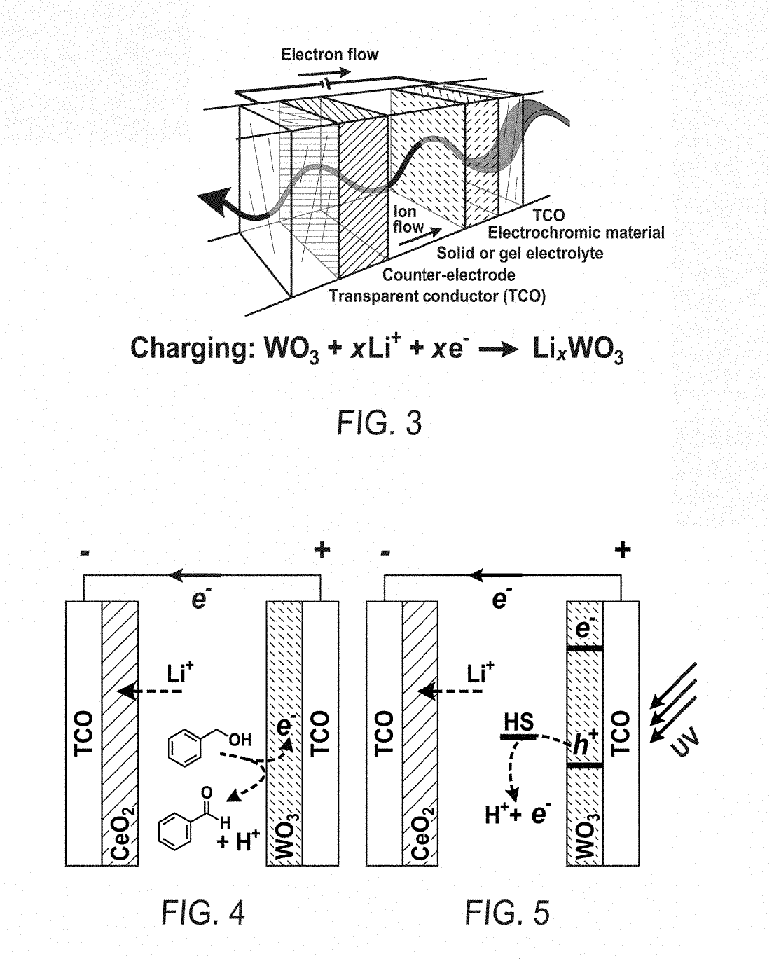

There are a variety of materials that possess contrasting optical properties under different conditions. One industrial application for this property is in the area of “smart windows,” though other applications such as optical filters and displays can be envisioned. A representative class of “smart windows” is electrochromics. Electrochromic devices undergo optical changes under electrochemical bias, thus providing light management on demand As many electrochromic devices work like a lithium ion battery, they require charging before operation (FIG. 3). Charging means storage of electrons and lithium ions into the electrodes of the electrochromic devices.

Conventional charging methods for electrochromic devices can be categorized into two different types. One is pre-charging, such as H₂ gas reduction and electrochemical reduction with Li metal, which is normally conducted before device assembly. However, these methods normally require inert or well-controlled atmosphere, and thus they are difficult to scale up. The other type of charging is in-device charging, which is performed after device assembly and can be easily scaled-up. A common in-device charging method is to electrochemically oxidize a sacrificial electron donor to generate electrons for charging (FIG. 4). However, this oxidation reaction often requires a high electrochemical bias (e.g., >2.5 V) that can lead to decomposition of electrodes and/or electrolyte components, thus affecting the device durability. The electrochromic materials in the devices described herein, such as WO₃, are wide-bandgap semiconductors that can absorb solar energy and convert it to electrons, which can then be transferred and stored at a counter electrode, such as CeO₂. The systems and methods described herein show that similar charge density can be obtained at a lower bias (e.g., ≤2 V) under ultra-violet or solar irradiation, thus improving the device durability. The electrochromic devices described herein can be used in devices such as solar cells and batteries, which can generate and store solar energy.

System 1

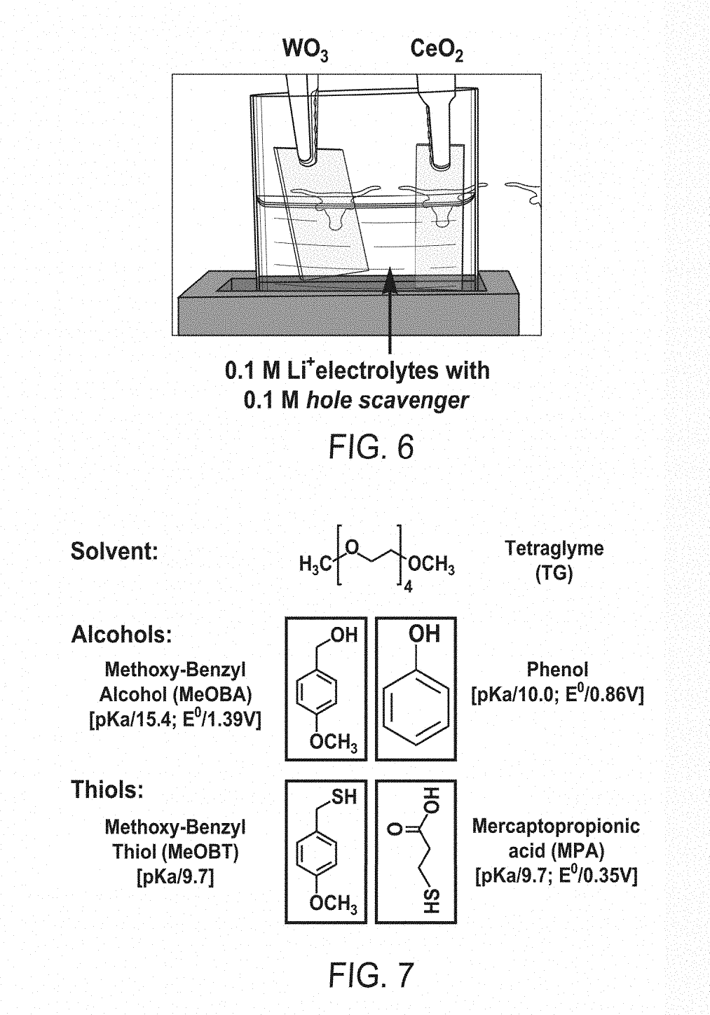

An electrochromic working electrode (e.g., WO₃) is used as a photo-electrode to absorb ultra-violet (UV) light, generating electrons and holes. Under a small bias (e.g., ≤2 V), the electrons (e⁻) in the conduction band of the electrochromic working electrode (e.g., WO₃) are swept to a counter electrode (e.g., CeO₂), while the holes (h⁺) in the valence band of the electrochromic working electrode (e.g., WO₃) are removed by an organic hole scavenger. An example device of this type is shown in FIG. 5 and FIG. 6.

An organic hole scavenger should be a compound that is clear and has an irreversible reaction upon contact with a hole. Various organic hole scavengers were tested in the device shown in FIG. 5 and FIG. 6 using tetraglyme as the solvent. The organic hole scavengers tested included methoxy-benzyl alcohol (MeOBA; pKa=15.4; E⁰=1.39 V), phenol (pKa=10.0; E⁰=0.86 V), methoxy-benzyl thiol (MeOBT; pKa=9.7), and mercaptopropionic acid (MPA; pKa=9.7; E⁰=0.35 V) (FIG. 7).

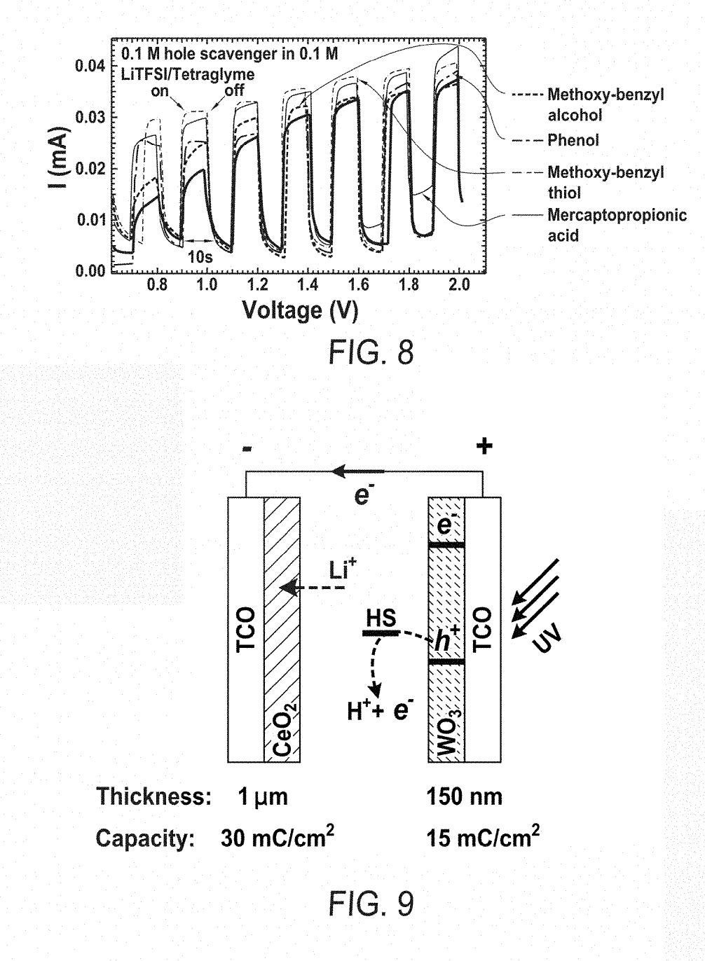

The performance of the various hole scavengers were determined by comparing the photocurrent of the device at different voltages with the lights on and off (FIG. 8). The results in FIG. 8 show that the photocurrent is 4-6 times higher than the dark current for all systems and at all voltages; at low V (e.g. 1 V), the thiols gave higher photocurrent, due to a lower pKₐ, E⁰, and thus more efficient proton coupled electron transfer (PCET); and at high V (e.g. 2 V), the solvent (tetraglyme (TG)) was also photo-oxidized.

All the tested hole scavengers help stabilize the photocurrent. The results in FIG. 8 indicate that mercaptopropionic acid performed the best. Of the four hole scavengers tested, mercaptopropionic acid has the lowest pKa and E⁰. The —COOH groups of mercaptopropionic acid can potentially bind to the WO₃ surface of the electrochromic electrode. Also, mercaptopropionic acid has a higher diffusivity that the other tested hole scavengers because of its smaller molecular weight. The 10 s photocurrent for the system using mercaptopropionic acid as the organic hole scavenger indicates that a sufficient charge capacity could be obtained by photocharging the device for about 20 minutes (FIG. 8). Photocurrent is usually limited by the diffusivity of hole scavengers, the charge capacity of the counter electrode (e.g., CeO₂), and the presence of traps in the electrodes.

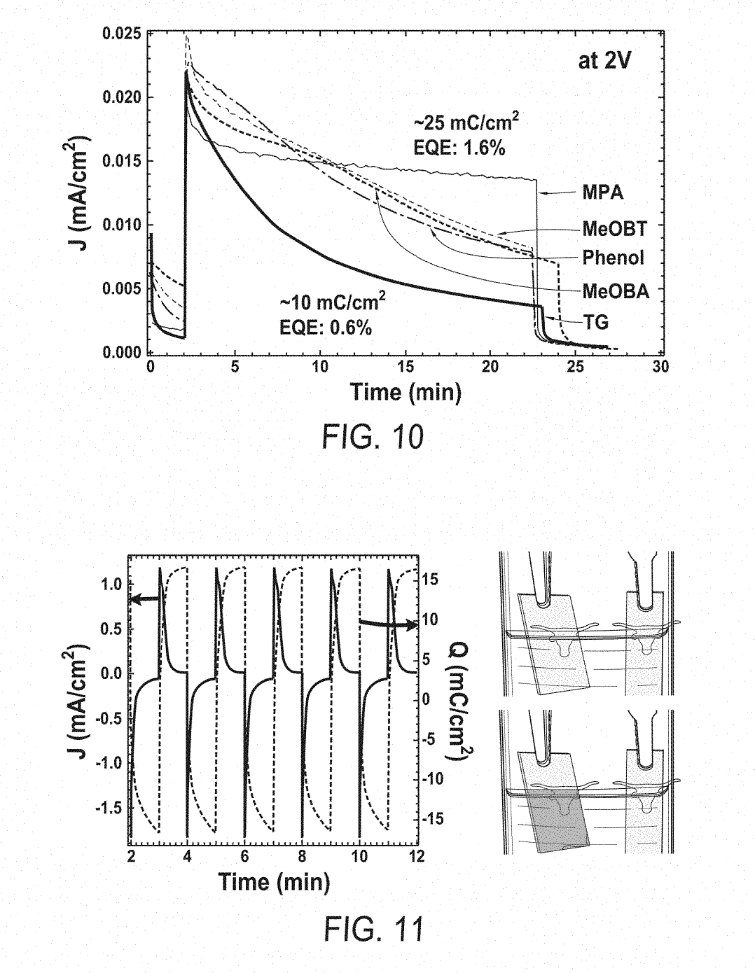

For a device of this type, a counter electrode with a 1 μm thick CeO₂ layer has a charge capacity of 30 mC/cm² at counter electrode and an electrochromic electrode with a 150 nm thick WO₃ electrochromic layer has a theoretical charge capacity of 15 mC/cm² (FIG. 9). The stability of the device shown in FIG. 9 was tested with the four organic hole scavengers at a voltage of 2 V, and the results are shown in FIG. 10. As can be seen in FIG. 10, the device with mercaptopropionic acid as the hole scavenger had the most stable photocurrent. The photo-generated electrons are stored in the counter electrode (e.g., CeO₂) with lithium ion compensation, thus charging the electrochromic device. A charge capacity of 25 mC/cm² can be reached with 20 minutes of photocharging at 2 V. After photocharging, the initially photo-generated electrons can be moved back and forth between the electrochromic working electrode (e.g., WO₃) and the counter electrode (e.g., CeO₂) by applying −2 V to the WO₃ (e.g., by applying 2 V to the CeO₂), thus reversibly switching the device. For example, the WO₃ can switch between a dark (e.g., blue) and clear (e.g., transparent) state (FIG. 11, right panels). The left panel of FIG. 11 shows a graph of current (black trace, left axis) and charge density (red, right axis) for 5 full charge and discharge cycles of the electrochromic switching for a photocharged WO₃ film with mercaptopropionic acid as the hole scavenger that was dispersed in 0.1 M LiTFSI in Tetraglyme.

System 2

Even with photocharging, the use of organic hole scavengers can be problematic for long-term device durability. Therefore, a second device was also tested (System 2), which completely removed the need of sacrificial electron donors by using an anodic electrochromic material (e.g., NiO) as the hole acceptor and counter electrode, thus avoiding potential unwanted side reactions. This method utilizes the electrochromic properties of both WO₃ and NiO, and it is capable of delivering higher optical contrast by using the same amount of charge, compared to System 1. More importantly, the photocharging method described can use abundant sunlight as the energy source, thus offering significant advantages in reducing manufacturing cost and improving production yield, compared to convention charging methods.

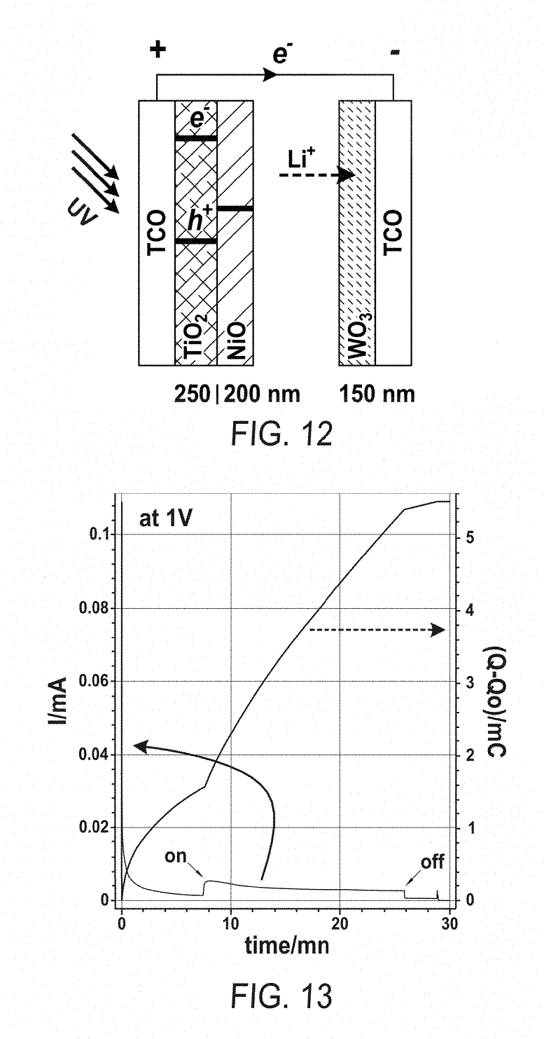

An example device for System 2 is shown in FIG. 12, where TiO₂ was used as a light absorber (e.g., TiO₂), on top of which a layer of a counter electrode (e.g. NiO) was deposited, e.g., by spin or spray coating or sputtering techniques. Under solar irradiation and a small bias (e.g., ≤2 V), the photo-generated electrons (e⁻) in TiO₂ transfer to the WO₃ working electrode with lithium ion compensation, thus charging the device, while the holes (h⁺) transfer to NiO due to their energy alignment. Because WO₃ and NiO have cathodic electrochromism and anodic electrochromism respectively, the photo-generated electrons and holes can color them simultaneously (e.g., one photo creates two absorbers, h⁺ colors NiO and e⁻ colors WO₃), which leads to better coloration efficiency and lower material required than in the case of System 1.

The electrochromic device shown in FIG. 12 was tested by placing the electrodes in an electrolyte of 0.1 M LiTFSI in tetraglyme. A voltage of 1 V was applied by a potentiostat onto the TiO₂/NiO electrodes. The dark current was allowed to reach an equilibrium before the UV light was turned on and the UV exposure was maintained for 15-20 mins to reach desired charge density. The current (blue trace, left axis) and charge (red trace, right axis) during photocharging for the electrochromic device of System 2 are shown in FIG. 13. The observed photocurrent indicates the photo-generated electrons and holes going to WO₃ and NiO, respectively (FIG. 13).

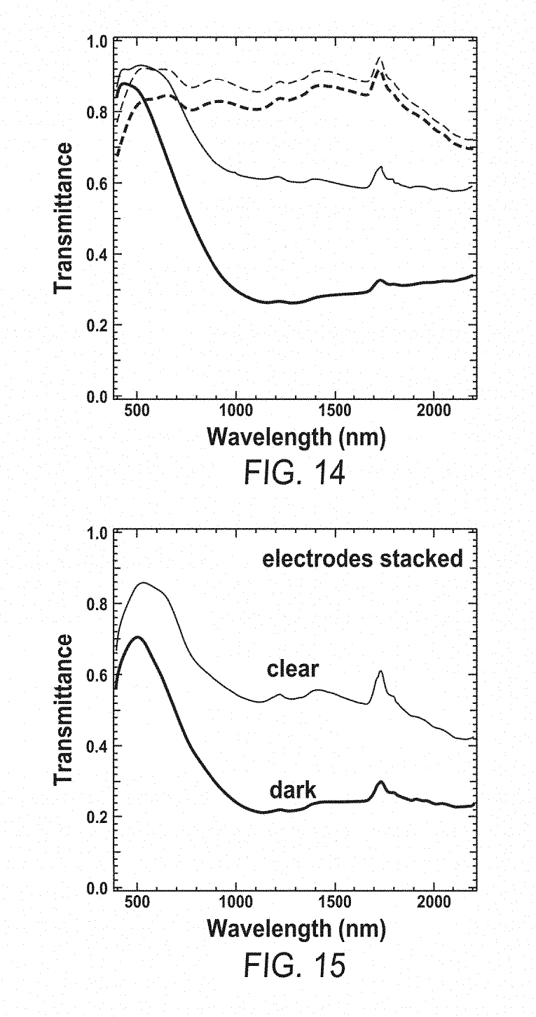

FIG. 14 shows the transmittance spectra in the clear and dark state for WO₃ (blue) and NiO (orange) before (thin lines) and after (thick lines) photocharging of the device in FIG. 12. After photocharging, the transmittance of both WO₃ and NiO was reduced, because of photo-induced electron and hole transfer from the TiO₂ (FIG. 14).

FIG. 15 shows the transmittance spectra in the clear and dark state when the WO₃ and NiO are stacked together. The clear and dark state can be reached by applying 2 V and −2 V.

The devices and methods of the appended claims are not limited in scope by the specific devices and methods described herein, which are intended as illustrations of a few aspects of the claims and any devices and methods that are functionally equivalent are within the scope of this disclosure. Various modifications of the devices and methods in addition to those shown and described herein are intended to fall within the scope of the appended claims. Further, while only certain representative devices and methods, and aspects of these devices and methods are specifically described, other devices and methods and combinations of various features of the devices and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. An electrochromic device, comprising:
an electrochromic electrode comprising a first conducting layer and an electrochromic layer, wherein the first conducting layer is in electrical contact with the electrochromic layer;
a counter electrode comprising a second conducting layer and a counter layer, wherein the second conducting layer is in electrical contact with the counter layer; and
an electrolyte comprising a hole scavenger and an ion source;
wherein the first conducting layer is in electrical contact with the second conducing layer; and
wherein the electrochromic layer and the counter layer are in electrochemical contact with the electrolyte.

2. The electrochromic device of claim 1, wherein the counter layer comprises CeO₂, IrO₂, NiO, Prussian blue, an electrochromic polymer, or combinations thereof.

3. The electrochromic device of claim 1, wherein the counter layer has a thickness of from 500 nm to 2000 nm; wherein the electrochromic layer has a thickness of from 200 nm to 1000 nm; or a combination thereof.

4. (canceled)

5. The electrochromic device of claim 1, wherein the hole scavenger comprises a compound with an oxidation potential of 1.4 V or less.

6. (canceled)

7. The electrochromic device of claim 1, wherein the hole scavenger comprises methoxybenzyl alcohol, phenol, methoxy-benzyl thiol, mercaptopropionic acid, 6-mercaptohexanoic acid, 11-mercaptoundecanoic acid, benzyl alcohol, 4-nitrobenzyl alcohol, 4-chlorobenzyl alcohol, 4-methylbenzyl alcohol, 3-methoxybenzyl alcohol, 2-methoxybenzyl alcohol, or a combination thereof.

8. (canceled)

9. (canceled)

10. (canceled)

11. An electrochromic device, comprising:
an electrochromic electrode comprising a first conducting layer and an electrochromic layer, wherein the first conducting layer is in electrical contact with the electrochromic layer;
a counter electrode comprising a second conducting layer, a photosensitive layer, and a hole scavenger layer, wherein the photosensitive layer is disposed between the second conducting layer and the hole scavenger layer such that the photosensitive layer is in electrical contact with the second conducting layer and the hole scavenger layer; and
an electrolyte comprising an ion source;
wherein the first conducting layer is in electrical contact with the second conducting layer; and
wherein the electrochromic layer is in electrochemical contact with the electrolyte.

12. The electrochromic device of claim 11, wherein the hole scavenger layer comprises NiO, IrO₂, Prussian blue, an electrochromic polymer; or combinations thereof; wherein the hole scavenger layer comprises an electrochromic material, such that the hole scavenger layer comprises a second electrochromic layer that is different than the first electrochromic layer; or a combination thereof.

13. (canceled)

14. (canceled)

15. (canceled)

16. (canceled)

17. (canceled)

18. (canceled)

19. (canceled)

20. The electrochromic device of claim 11, wherein the hole scavenger layer comprises an electrochromic material, such that the hole scavenger layer comprises a second electrochromic layer that is different than the first electrochromic layer and wherein the second electrochromic layer has a thickness of from 200 nm to 500 nm.

21. The electrochromic device of claim 11, wherein the hole scavenger layer comprises an electrochromic material, such that the hole scavenger layer comprises a second electrochromic layer that is different than the first electrochromic layer and wherein the second electrochromic layer has a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more at one or more wavelengths from 400 nm to 2200 nm, and wherein the second electrochromic layer can be switched from the first optical state to the second optical state and/or from the second optical state to the first optical state upon application of a potential to the counter electrode.

22. (canceled)

23. The electrochromic device of claim 11, wherein the photosensitive layer comprises Si, TiO₂, GaN, GaAs, CdSe, CdS, CdTe, ZnO, Cu₂S, SnS, InGaN, CdZnTe, Fe₂O₃, or combinations thereof.

24. (canceled)

25. The electrochromic device of claim 11, wherein the photosensitive layer has a thickness of from 100 nm to 500 nm: wherein the electrochromic layer h is a thickness of from 200 nm to 1000 nm; or a combination thereof.

26. (canceled)

27. The electrochromic device of claim 1, wherein the electrochromic device has charge capacity of 10 mC/cm² or more after 20 minutes or less of photocharging at an applied voltage of 2 V or less.

28. An electrochromic device comprising:
an electrochromic electrode comprising an electrochromic layer and a first conducting layer;
an electrolyte comprising an ion source; and
a counter electrode comprising a second conducting layer;
wherein the electrochromic electrode is in electrical contact with the counter electrode;
wherein the electrochromic electrode and the counter electrode are in electrochemical contact with the electrolyte; and
wherein the electrochromic device has charge capacity of 10 mC/cm² or more after being photocharged for 20 minutes or less at an applied electrical bias of 2 V or less.

29. (canceled)

30. (canceled)

31. (canceled)

32. (canceled)

33. The electrochromic device of claim 1, wherein the electrochromic layer comprises WO₃, MoO₃, V₂O₅, Nb₂O₅, TiO₂, Ta₂O₅, or combinations thereof.

34. (canceled)

35. (canceled)

36. (canceled)

37. (canceled)

38. The electrochromic device of any one of claim 1, wherein the electrochromic layer has a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more at one or more wavelengths from 400 nm to 2200 nm, and wherein the electrochromic layer can be switched from the first optical state to the second optical state and/or from the second optical state to the first optical state upon application of a potential to the electrochromic electrode.

39. The electrochromic device of claim 1, wherein the first conducting layer and/or the second conducting layer comprise(s) a transparent conducting oxide, a carbon material, a nanostructured metal, or a combination thereof.

40. (canceled)

41. (canceled)

42. The electrochromic device of claim 1, wherein the first conducting layer and/or the second conducting layer comprise(s) CdO, CdIn₂O₄, Cd₂SnO₄, Cr₂O₃, CuCrO₂, CuO₂, Ga₂O₃, In₂O₂, NiO, SnO₂, ZnGa₂O₄, ZnO, InZnO, InGaZnO, InGaO, ZnSnO, Zn₂SnO₄, CdSnO, WO₃, or combinations thereof.

43. (canceled)

44. (canceled)

45. (canceled)

46. (canceled)

47. (canceled)

48. (canceled)

49. (canceled)

50. (canceled)

51. (canceled)

52. A method of use of the electrochromic device of claim 1, the method comprising using the electrochromic device in a touch panel, an electronic display, a smart window, a transistor, or a combination thereof.

53. (canceled)

54. A method of photocharging the electrochromic device of claim 1, the method comprising:
illuminating the electrochromic layer with electromagnetic radiation at a wavelength that overlaps with at least a portion of the band gap of the electrochromic layer, thereby generating electron-hole pairs in the electrochromic layer; and
applying an electrical bias to the electrochromic device to thereby separate the electron-hole pairs by driving the electrons to the counter Layer, thereby driving the holes to the electrolyte to react with the hole scavenger, and driving ions to the counter layer to compensate for the electrons;
thereby photocharging the electrochromic device.

55. A method of photocharging the electrochromic device of claim 11, the method comprising:
illuminating the photosensitive layer with electromagnetic radiation at a wavelength that overlaps with at least a portion of the band gap of the photosensitive layer, thereby generating electron-hole pairs in the photosensitive layer; and
applying an electrical bias to the electrochromic device to thereby separate the electron-hole pairs by driving the electrons to the electrochromic layer, thereby driving the holes to the hole scavenger layer, and driving ions to the electrochromic layer to compensate for the electrons;
thereby photocharging the electrochromic device.

56. (canceled)

57. (canceled)

58. (canceled)

59. (canceled)

60. (canceled)
